(19) United States
(12) Patent Application Publication
(10) Pub. No.: US 2006/0213721 A1
(43) Pub. Date: Sep. 28, 2006

(54) Multiple laddering system - the ultimate foldaway system

(76) Inventors: Mario Uttaro, New Britain, CT (US); William King, Farmington, CT (US)

Correspondence Address: MARIO UTTARO, 54 ELTON ST, NEW BRITAIN, CT, 06053, US

(21) Appl. No.: 11/089,198

(22) Filed: Mar. 25, 2005

(51) Int. Cl. E06C 1/00

(52) U.S. Cl. 182/22

(57) ABSTRACT

A collapsible enfolding ladder arrangement comprising of: Channel Uprights, Pivotal Rungs, Hinges, Adapter Latches and Top and Bottom Levelers. Including Accessories: Lock bars, Retainers and Pins. When applied appropriately produce Step Stools, Step Ladders and Extension units. This invention considers numerous positioning patterns as it unfolds from a unique stowed berth. Usefully noted in both commercial and residential environments with obvious advantages for handling and storage convenience and answering savings in transportation needs.

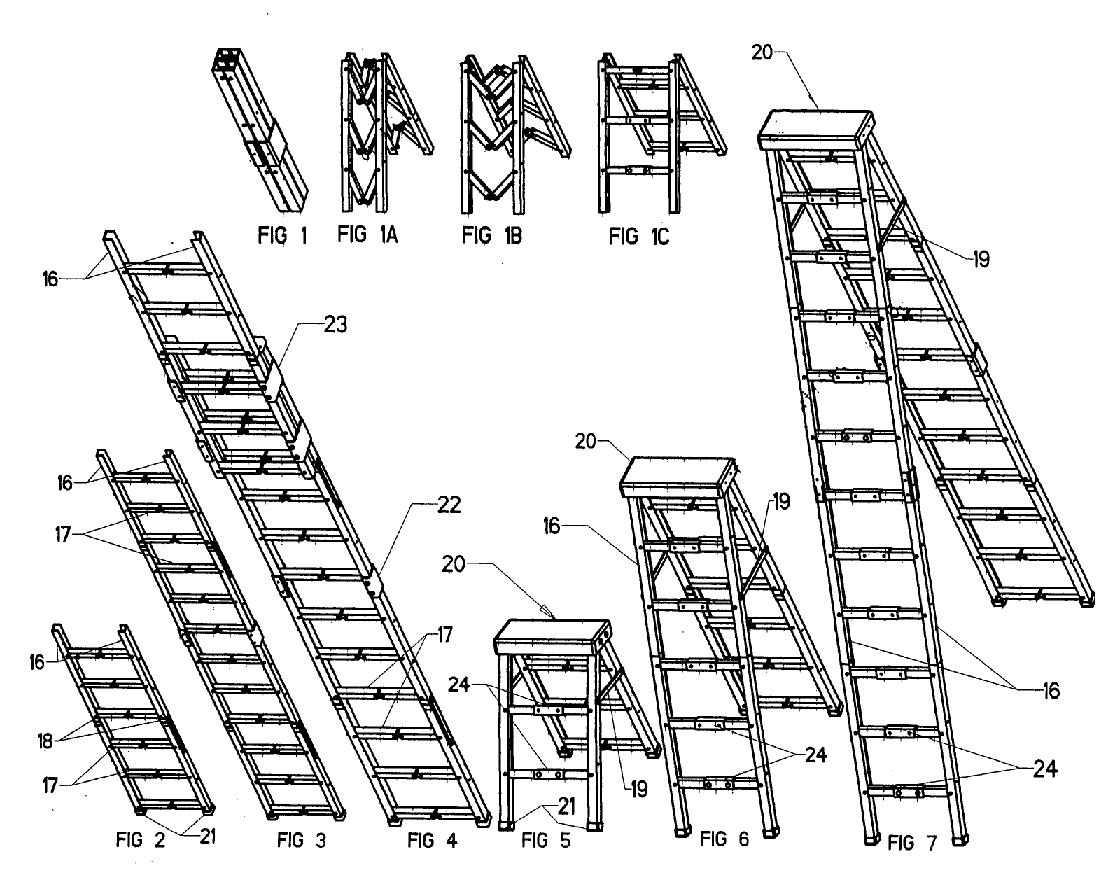

FIG. 1

Depicts initial or final stowed arrangement, emphasizing its unique ability for convenient handling, storage and savings in transportation needs.

FIGS. 1A, 1B & 1C

Illustrates folding and unfolding modes, utilizing accessories, locking and retaining devices as required.

FIGS. 2, 3 & 4

Demonstrates various extension abilities, applying accessories to achieve maximum requirements.

FIGS. 5, 6 & 7

Portrays several stepladder arrangements, beginning with minimal step stool & upwards to typical step laddering systems & heights.

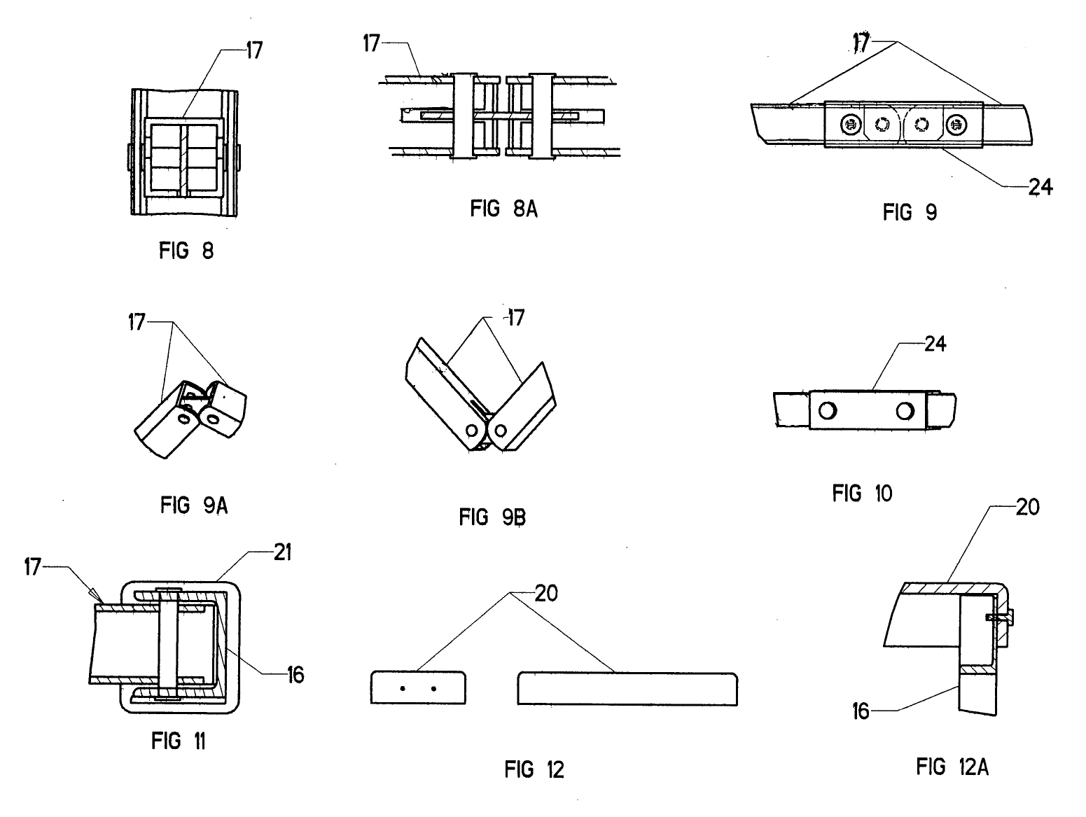

FIGS. 8 & 8A

Sections thru central pivotal rung areas revealing two piece rung (17), bonded together with detention bar with two pins attachment, permitting folding and unfolding progression (FIGS. 9, 9A & 9B). Detention bar plays vital role in necessary movements and locks in horizontal position.

FIGS. 9, 9A & 9B

Symbolizes pivotal rung motions in its various capabilities.

FIG. 10

Use of retainers on stepladder systems downsides, preventing rungs from unwanted movement.

FIG. 11

Typical section thru channel upright (16) & rung (17) with pinning attachment.

FIGS. 12 & 12A

Shows top levelers (20) & section depicting connection to channel upright (16) in stepladder systems.

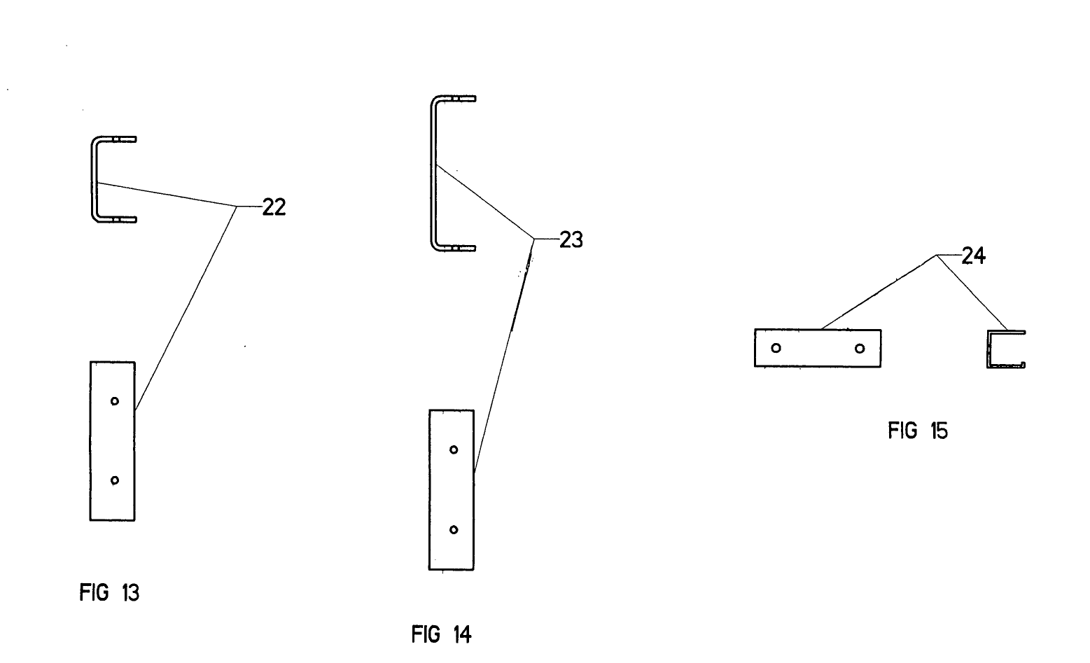

FIG. 13

Outlines single lock bracket (lock pins & cotter pins required at assembly)

FIG. 14

Outlines dual lock brackets (lock pins & cotter pins required at assembly)

FIG. 15

Outlines retainers (lock pins & cotter pins required at assembly)

### DRAWING: NUMERICAL REFERENCE PARTS INDEX

(16) Channel uprights
(17) Pivotal rungs with detention bars and pins
(18) Hinges
(19) Adapter latches
(20) Top levelers
(21) Bottom levelers

### DRAWING: NUMERICAL REFERENCE ACCESSORY INDEX

(22) Single lock bracket
(23 Dual lock bracket
(24) Retainer

1. After freeing from stowed position one can proceed to the following:
1. Extension ladder systems: From minimal to maximum settings advancing by 12 inch increments utilizing appropriate parts and accessories.
2. Step ladder systems: From minimal step stool to maximum stepladders utilizing appropriate parts and accessories.
3. Additional abilities: platform and scaffolding modes utilizing suitable planking.
Note:
Although invention shown and described it is understood, various additions or omissions may be made without departing from its spirit and scope.
